(19) United States
(12) Patent Application Publication
(10) Pub. No.: US 2026/0261616 A1
(43) Pub. Date: Sep. 3, 2026

(54) ARTIFICIAL INTELLIGENCE (AI) DRIVEN AUTOMATED VOICE CALLING SYSTEM AND METHOD FOR PERSONALIZED CUSTOMER COMMUNICATION

(71) Applicant: Trilogy Enterprises, Inc., Austin, TX (US)

(72) Inventors: Todd Ramsey, Ontario (CA); Arthur Michel, Brooklyn, NY (US)

(73) Assignee: Trilogy Enterprises, Inc., Austin, TX (US)

(21) Appl. No.: 19/378,297

(22) Filed: Nov. 3, 2025

Related U.S. Application Data
(60) Provisional application No. 63/714,911, filed on Nov. 1, 2024.

(51) Int. Cl. H04M 3/51; G06F 40/166; G06F 40/40; H04M 3/42

(52) U.S. Cl. CPC H04M 3/5183; G06F 40/166; G06F 40/40; H04M 3/5175; H04M 3/42221; H04M 2201/405; H04M 2203/2061

(57) ABSTRACT

An AI-based automated voice dialer system integrates AI-driven insights and personalized automated calls to enhance customer satisfaction and retention. The system utilizes a customer management database to store personal and engagement data, feeding the data to a conversational tool with a script generator and calling feature. The scripts are tailored using customer history, AI-generated insights, and past call data. Post-call, summaries and transcripts are sent via API to a workflow automation tool, which forwards data to account executives and a signal generator. The signal generator analyzes unstructured data to detect trends or customer sentiments, such as renewal inquiries or pricing concerns. These insights guide executives and AI engines in crafting responses. Account executives prompt the AI engine for professional, neutral replies, avoiding jargon, while the AI updates the database with new data, refining future interactions. Such a system ensures proactive issue resolution and improved customer experiences.

### CROSS-REFERENCE TO RELATED APPLICATION(S)

This application claims the benefit under 35 U.S.C. § 119(e) and 37 C.F.R. § 1.78 of U.S. Provisional Application No. 63/714,911, which is incorporated by reference in its entirety.

### FIELD OF THE INVENTION

The present invention relates in general to the field of electronics and more specifically to a system and method utilizing artificial intelligence for generation of personalized scripts and automated voice calling to improve customer success.

### BACKGROUND OF THE INVENTION

Customer success is a proactive business strategy implemented by various companies to ensure customers achieve their desired outcomes while using their products or services. Customer success aims to enhance customer satisfaction and loyalty by helping customers derive maximum value from the offerings. The customer success team plays an important role in a customer's journey after the purchase of products or services.

The customer success team ensures that customers achieve their goals through effective onboarding, helping them understand the product's full capabilities, and proactively addressing their challenges. The customer success teams ensure a comprehensive and value-driven customer experience by monitoring customer's feedback, building long-term relationships, and focusing on retention, upselling, and cross-selling opportunities. The customer success team also collect feedback to enhance the product and act as a bridge between customers and internal teams.

An aspect of customer success is actively collecting and analyzing customer data to understand their needs and provide solutions. Teams gather information from various sources, such as usage metrics, feedback forms, and support tickets, and then analyze it to identify trends, pain points, and growth opportunities. Customer success team members often make calls to customers to provide guidance, address concerns, and build stronger relationships. These interactions strengthen engagement and offer real-time support for customer issues.

The conventional technology used in customer success often relies on manual processes that are time-consuming and prone to human error. The challenges of manual processes are further complicated by the need to serve customers across varied geographies. This requires teams to operate in multiple shifts, which increases staffing costs and adds logistical complexity. Additionally, language barriers frequently arise when interacting with customers from diverse linguistic backgrounds, impacting the consistency of these interactions. Moreover, reliance on human experts introduces variability in customer experiences, as individual styles and approaches can differ.

These challenges make it difficult to scale customer success efforts without significant resource allocation. The combination of higher costs, inconsistencies in customer experience, and the limitations of manual processes highlights the need for automation tools. Such tools can streamline operations, create more engaging interactions, and deliver personalized solutions, enabling teams to operate more efficiently while maintaining high-quality service.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary AI-based automated voice dialer system that creates personalized scripts for an automated conversational system.

FIG. 2 depicts an exemplary AI-based automated voice dialer process using the AI-based automated voice dialer system of FIG. 1.

FIG. 3 depicts an exemplary workflow of the AI-based automated voice dialer system of FIG. 1 using exemplary components.

FIG. 4 depicts an exemplary network environment in which the system of FIG. 1 and the process of FIG. 2 may be practiced.

FIG. 5 depicts an exemplary computer system.

### DETAILED DESCRIPTION

An AI-based automated voice dialer system that utilizes a combination of software tools to create a seamless customer success program is described. The AI-based automated voice dialer system integrates artificial intelligence (AI) driven insights and personalization with automated voice calls to maximize customer satisfaction and retention. The AI-based automated voice dialer system includes a customer management database, which stores customer details including customers' personal information, historical engagement of the customer with one or more products, and so on. The customer details are shared with a conversation tool and an AI engine as input data.

The conversational tool includes a script generation tool and a calling tool. The script generation tool creates personalized scripts using conversation history, which includes past call data and customer data retrieved from the customer management database. Additionally, the script generation tool uses insights generated by the AI engine for personalized script generation. The call data includes the call summary and transcript of the previous calls. The conversational tool provides a set of prompts to the AI engine to guide it to generate insights on customer preferences based on the updated call data post-completion of the voice call with the customer. The conversational tool connects with a workflow automation tool by sending an application programming interface (API) request. The workflow automation tool accepts the API request and the call summary and transcript are transferred to the workflow automation tool. The workflow automation tool then triggers actions and sends the call summary and transcript to the account executives through email or chat platforms (e.g., Google Chat). The workflow automation tool further transfers the call summary and transcript to a signal generator. The signal generator analyzes unstructured data such as call summaries, emails, or chats and generates signals. The result of the data analysis by analyzing keywords, phrases, or sentiments forms the basis of the signal. The signal may indicate a happy customer or potential customer issue associated with pricing or inquiry regarding a renewal. These signals are shared with the AI engine for analysis which helps in generating insights. These signals are also transferred to the account executives for further addressing the issues identified in the signals.

Based on the information captured through the signals, the account executives further interact with the AI engine through a set of prompts. The prompts contain instructions for the AI engine to generate personalized responses against the queries asked by the account executives. The AI engine is equipped with tools to identify and analyze patterns in customer behavior including historical engagement data. The prompts additionally include instructions for the AI engine to generate responses in a professional and neutral tone avoiding the usage of jargon. The AI engine, which now has access to the call summary and transcript further updates the customer management database that is used to generate future responses.

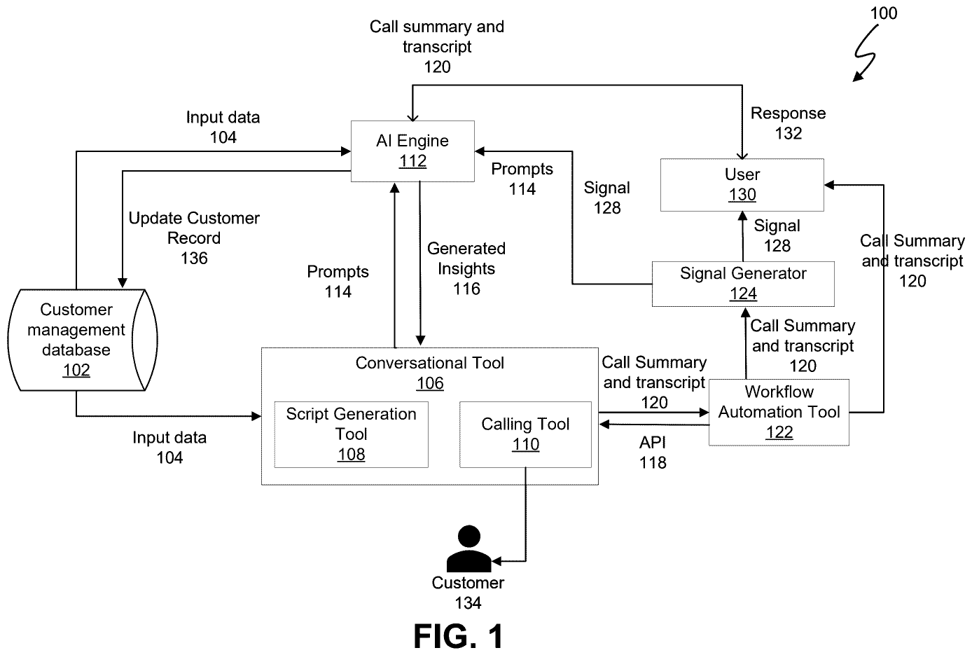

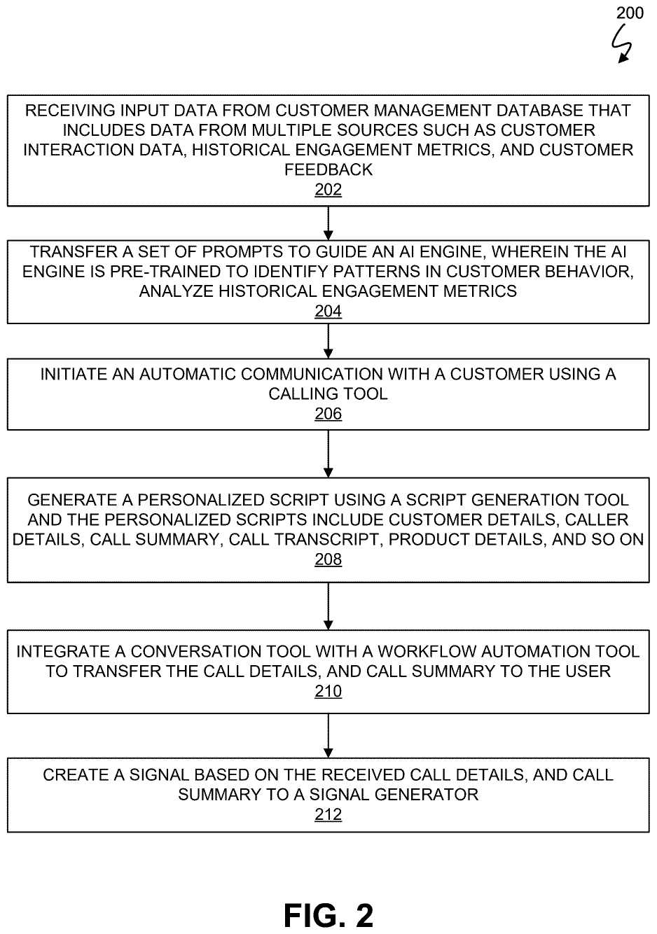

FIG. 1 depicts an AI-based automated voice dialer system 100, designed to enhance customer engagement and retention through personalized communication and advanced predictive data analytics. FIG. 2 depicts an AI-based automated voice dialer process 200 utilized by the AI-based automated voice dialer system 100.

Referring to FIGS. 1 and 2 in operation 202, receiving input data from a customer management database 102 that includes data from multiple sources such as customer interaction data, historical engagement metrics, and customer feedback. The AI-based automated voice dialer system 100 includes a customer management database 102, which is a structured repository of customer-related information collected through multiple sources. The customer management database 102 enables companies to centralize and organize customer-related information. This customer-related information is analyzed to make informed decisions, which lead to enhanced customer engagement and satisfaction. The customer management database 102 includes detailed profile of each customer 134 including his/her name, email, and phone number, and demographic information such as age and location. Additionally, the customer management database 102 contains details about customer's product purchase history, experiences, and preferences. Further, the customer management database 102 records customer's interaction history with the company through phone calls, emails, meetings, and support tickets. The customer 134 interaction history includes all the touchpoints between the customer and the company, which allows the company to track customer's journey from the initial point of communication to advanced stages such as inquiry, lead generation, product evaluation, purchase, and so on. Access to the customer interaction history allows the company to have a comprehensive view of how the customer 134 has engaged with the company and its products over time.

The customer's 134 interaction data also include customer's feedback on previously used products. The customer feedback is recorded to understand their experience with the products, level of satisfaction, suggested areas for improvement, and detailed insights related to the features of the products for any future improvements in the product. Customer feedback is recorded through data available via survey forms filled in by customers, online reviews posted by customers and voice call information obtained through direct communication. The company uses customer's interaction data to plan follow-up activities to be performed by the company after the customer subscribes for the product. These follow-up activities include but are not limited to periodic check-ins, which is a meeting between the company manager and the customer, sending reminders to customers for service renewals for maintaining ongoing engagement with the customer, receiving product feedback from the customer, and offering complementary products. Therefore, the data pertaining to post-product purchase customer interactions allows companies to identify opportunities for loyalty programs, upselling, cross-selling, or even requesting referrals, ensuring that the customer feels valued. This structurally organized customer transactional and interaction data within the customer management database 102 enables the company to group customers based on criteria such as location, purchase behavior, or demographics. This segmentation further supports targeted marketing campaigns and personalized communication. The customers' 134 interaction data with the company is updated continuously even after the product purchase. This updated information may pertain to any issues or concerns raised by the customer after purchasing a product or service. The information also includes communication regarding any troubleshooting requests, warranty claims, or inquiries about product usage. This ensures that the company provides timely and effective assistance to customer's grievances.

The existing customer's information within the customer management database 102 is labeled as input data 104. This input data 104 is accessed by a conversational tool 106 as a comma-separated values (CSV) file, which is a simple text file used for structural storage of data. Each line within the CSV file denotes a row of data. The data entries corresponding to each row are delimited by commas. The CSV file is used for storing and exchanging tabular and structured data as they are lightweight and easy to read. Additionally, the compatibility of CSV files with software tools such as Microsoft Excel and programming languages such as Python further facilitates their widespread use in data management, analysis, and processing tasks. Therefore, CSV files are a preferable choice for seamless transfer of data between systems and applications. The input data 104 in the CSV file format includes customer information such as phone numbers, customer name, email address, company name and the product that is being used by the customer. The CSV also includes the information on the company account executive labeled as user 130. The details include the name and email address of the user 130.

The input data 104 is shared with the conversational tool 106 to execute engaging and contextually relevant communications with the customer 134. The conversational tool 106 achieves this through the analysis and interpretation of the input data 104 by leveraging an AI engine 112, which utilizes artificial intelligence for performing tasks such as data analysis, decision-making, and making predictions. The AI engine 112 uses a combination of machine learning models and natural language processing tools for understanding patterns, interpreting language, and generating meaningful insights or responses. The AI engine 112 leverages a Large Language Model (LLM) to enhance its capabilities. The Large Language Model (LLM) is an advanced artificial intelligence system designed primarily to understand and generate responses that emulate human language. Such LLMs are trained in a vast amount of text data and utilize deep learning techniques, particularly neural networks, to process and predict language patterns. Additionally, the Large Language Model (LLM) can perform tasks such as writing, translating, generating responses to questions, and engaging in conversations. Some of the exemplary LLMs that can be used herein include OpenAI GPT-4 (Generative Pre-trained Transformer 4) and BERT (Bidirectional Encoder Representations from Transformers).

The conversational tool 106 is a third-party software configured to facilitate real time interactions with customers. The mode of customer interactions can be voice or text based. The conversational tool 106 further includes a script generation tool 108 and a calling tool 110, where the script generation tool 108 is used to generate personalized scripts tailored for each customer 134 and the calling tool 110 is utilized to make phone calls to the customer 134. The personalized script is based on the input data 104 of the customer retrieved from the customer management database 102, call summary and transcript 120 and real-time analysis of the customer preferences provided by the AI engine 112. The call summary and transcript 120 include call information of customers acquired post-completion of voice calls through the calling tool 110. The AI engine 112 also receives the input data 104 from the customer management database 102. The AI engine 112 uses one or more machine learning algorithms to identify customer's preferences through analysis of the input data 104 including critical customer information such as the customer's interaction history with the company and his/her demographic details. The AI engine 112 is trained on diverse datasets to ensure accuracy in the personalization process and for generating dynamic content in multiple languages. This feature allows communication to surpass geographical and language boundaries and engages customers from different ethnic and demographic backgrounds.

In operation 204, transfer a set of prompts to guide the AI engine 112, wherein the AI engine 112 is pre-trained to identify patterns in customer behavior, and analyze historical engagement metrics. The conversational tool 106 shares prompts 114 with the AI engine 112 for guiding the AI engine 112 to generate output in the form of insights. Prompts 114 are used to trigger the AI engine 112 to generate dynamic responses based on the context of the real-time customer data available in the form of input data 104. Prompts 114 are tailored to handle requests by the user 130 from the AI engine 112 to analyze the call summary and transcript 120 and generate a personalized response 132. The generated insights 116 include strategic insights based on which the personalization script is generated for a specific customer. The generated insights 116 are dynamic and vary for each customer as the input data 104 for each customer is updated. Some of the instances where the input data 104 may be updated include—the completion of a voice call with the customer 134, changes made in the personal information of the customer 134, and so on. To that end, the personalization script generated by the script generation tool 108 for each customer is continuously updated with new customer preferences. The generated insights 116 therefore contain instructions to immediately adjust communication strategies and personalization aspects based on the signal 128 of customer's satisfaction levels.

After the analysis, the customer data including the conversation history is updated and updated customer records 136 are stored in the customer management database 102. The updated customer records 136 will facilitate tailored future communication by storing customer preferences and conversation history, enhancing team collaboration, and enabling data-driven decision-making.

In operation 206, initiate an automatic communication with a customer using a calling tool. The script generation tool 108 utilizes the generated insights 116 and generates personalized scripts tailored according to the preferences of different customers. If the customer 134 is newly acquired, the script generation tool 108 generates a personalized welcome message for him/her. The calling tool 110 is configured to automatically set up the voice call with all the customers whose phone numbers are present in the input data 104. The calling tool 110 includes the configuration to select a voice based on the customers' location and geographic area. The calling tool 110 is designed to mimic a human voice and then engage with the customer 134 based on the generated personalized script. The calling tool 110 also includes a predefined setting or criteria as to when the engagement with the customers 134 is allowed to be initiated. This criterion marks the instance when customer 134 initiates the call with conversation tool 106 via a greeting. This predefined setting ensures a smooth and controlled conversation with customers. Additionally, the calling tool 110 also has the functionality to call all the customers simultaneously from a single phone number and record the conversation with each customer 134.

In operation 208, generate a personalized script using a script generation tool and the personalized scripts include customer details, caller details, call summary, call transcript, product details and so on. After the completion of the voice call with customers, the conversational tool 106 generates the call summary and transcript 120 of the recorded conversations with the customer 134 in a JavaScript Object Notation (JSON) file format. A JSON file format is a lightweight, text-based format that is used for storing and sharing data. In a JSON format, information is organized in the form of key-value pairs, for ease of understanding by both humans and computers. JSON is not a programming language specific, meaning that it can be used by many programming languages for data sharing. JSON file data can include different types of data, like text, numbers, and lists. JSON file format is therefore a convenient information-sharing tool between different software systems. Based on the call summary and transcript 120, the input data, the user 130 details, and the generated insights 116, the script generation tool 108 generates personalized scripts tailored for different customers. The dynamic nature of the personalized scripts ensures that each time a voice call with the customer 134 is initiated, the conversation tool 106 is updated with the latest information related to the customer 134. This information also includes the details of the user 130 who is managing the customers' purchase preferences. If customers have some grievances or inquiries regarding their associated user 130, then the content in the personalized scripts is tailored to address these details through a follow-up call with customers.

In operation 210, integrate a conversation tool with a workflow automation tool to transfer the call details, and the call summary to the user. After the voice call with the customer 134 is completed, the conversational tool 106 sends a webhook or an Application Programming Interface (API) 118 request to a workflow automation tool 122. The Application Programming Interface 118 refers to a connection between different software applications and tools defined by a set of protocols. Application Programming Interface (APIs) enables the masking of underlying complex software processes during a connection between different software applications. This mechanism allows software developers to access the services between two applications without figuring out their implementation details.

The workflow automation tool 122 is a software tool designed to interact with multiple other software applications. It facilitates the flow of data between these applications and triggers specific actions based on customer interactions. Additionally, the workflow automation tool 122 enables these actions to be carried out automatically by the connected software applications, eliminating the need for human intervention. The conversation tool 106 sends the call summary and transcript 120 in the JSON format to the workflow automation tool 122 as input after the workflow automation tool 122 accepts the API 118 request. The workflow automation tool 122 processes the call summary and transcript 120 and triggers automation. The automation processes include sending the call summary and transcript 120 to the user 130 via email and through chat interfaces such as Google Chat. The purpose of automating the sending of call summary and transcript 120 to the user 130 via Google Chat is to notify user 130 that the voice call with the customer 134 has been completed.

Additionally, the workflow automation tool 122 also waits for triggers like a Google Form that is being filled by the customer 134. A Google Form is an online tool provided by Google that enables users to create customizable forms for collecting information. Google forms are multipurpose and are used for creating surveys, puzzles, feedback forms or for gathering research data. Google Forms are easy to create and have options to add text fields, dropdown menus, checkboxes, and much more. The collected information from the input responses is automatically saved and can be shared with other software tools via a link or email. The Google form can be accessed through a link and the customer 134 can fill in their personal information like name, phone numbers, the product being used including other additional information. After the information has been filled in by the customer 134, there is an option to send the information to the workflow automation tool 122. Once the send button is clicked by the customer 134, the workflow automation tool 122 triggers the conversational tool 106 to initiate a customer success call via the calling tool 110. This call is implemented to notify the customer 134 regarding the acknowledgment of the issues raised by them.

In operation 212, create a signal based on the received call details, and call summary to a signal generator. The workflow automation tool 122 also sends the received call summary and transcript 120 to a signal generator 124. The signal generator 124 is a software tool that analyzes the input received to identify specific triggers or signal 128 defined by customer response metrics during calls. Such triggers may indicate dissatisfaction, praise, or suggestions. An example could be a specific trigger that may arise due to concerns regarding product quality or pricing or an inquiry regarding a roadmap for product usage. The trigger may also include specific feedback about service quality or overall product experience. This feedback may contain both positive and negative remarks. The signal generator 124 through the generated signal 128 identifies patterns and actionable points. Signal 128 is forwarded to the user 130 to further notify them to take immediate follow-up action and act on customer insights. The signal generator 124 analyzes the call summary and transcript 120 of the multiple customers to see if certain issues like pricing complaints and product quality concerns are more common in one group than another. The signal generator 124 achieves this by integrating with the AI engine 112.

The AI engine 112 performs predictive analysis on the customer data which includes the call summary and transcript 120 and the existing customer historical engagement data. The predictive analysis is performed using predictive models such as neural networks or techniques like natural language processing (NLP). The results generated through predictive analysis help identify broader trends across all customer interactions and recommend actions such as prioritizing issues that affect a significant number of customers. The results further include recommending additional services to customers, scheduling follow-up communications with the customers, and addressing their concerns. The generated signal 128 by the signal generator 124 contains insights based on the results captured through predictive analytics. The AI engine 112 further uses the received call summary and transcript 120 along with the results of the predictive analysis to update the customer record by transferring the results of the predictive analysis back to the customer management database 102.

The user 130 receives the signal 128 from the signal generator 124. Signal 128 notifies them regarding any impending customer issues that need to be resolved. User 130 also has an option to directly interact with the AI engine 112 to gain further insights into a specific conversation pertaining to a customer. The user 130 can utilize the personalized generated response 132 to follow up with the customers as described previously. The user 130 can interact with AI engine 112 to receive transcripts, summaries, and additional information. The user 130 can also fetch the customer success rating for different products across different regions of the world. This is generated through a specific function call to the AI engine 112 requesting it to generate heat maps for the same. The AI engine 112 as described previously leverages Large Language Model (LLM) capabilities to process and analyze the accumulated real-time customer data. The AI engine 112 is further designed to answer queries by the user 130 provided as input through the dynamic prompts 114. A feature of the AI engine 112 is its ability to make function calls. Function call allows it to retrieve specific conversation data or call information as needed based on the user's 130 queries. This functionality adds versatility, ensuring that the user 130 can explore detailed analytics or focus on aspects of the call data.

In the above described method 200, the workflow automation tool 122 sends call summary and transcript 120 to the signal generator 124 in the form of an email. The signal generator 124 is a third-party software tool that analyzes the call summary and transcript 120 to generate the signal 128. The signal 128 is defined as a brief instruction that categorizes the overall conversation with customer 134 under different customer satisfaction metrics. The signal generator performs data analysis such as sentiment analysis and pattern analysis on the call summary and transcript 120. Signal 128 may identify a customer sentiment as positive, negative, or neutral. It may identify some potentially actionable items such as renewals, and cancellations. Signal 128 may also indicate a specific requirement from customer 134 about a company product that needs urgent attention. The signal generator 124 shares the call summary and transcript 120 along with the signal with the AI engine 112. The AI engine 112 is equipped with data analytics capability which compares the historical customer interaction data with the call summary and transcript 120 to generate insights 116 and predictive outcomes of the customer's 134 preferences. Predictive analytics by AI engine 112 helps in customer success by generating insights, identifying at-risk customers, predicting churn, and enabling proactive engagement to improve retention. It also personalizes customer experiences by analyzing behavior patterns and forecasting needs, ensuring better onboarding, increased product adoption, and more efficient resource allocation. The signal 128 generated is further transferred as an input to the user 130. The user 130 reviews the signal 130 along with the call summary and transcript 120 to check and address identified customer issues.

The user 130 additionally interacts with the AI engine 112 through the dynamic prompts 114 to inquire about the details of the individual calls from the customers. Prompts 114 are input provided by user 130 includes rules and guidelines for the AI engine 112 to analyze individual customer data based on the call summary and transcript 120. Prompts 114 also include instructions through which user 130 can further request detailed analytic insights on a specific conversion with the customer based on the call data. The response 132 generated by the AI engine 112 to user 130 is generally a text-based output. The AI engine 112 is also capable of generating charts, tables, plots, and even heat maps, depending on the specific instructions in the prompts 114. This is achieved due to the code interpretation and data analysis features enabled in the AI engine 112.

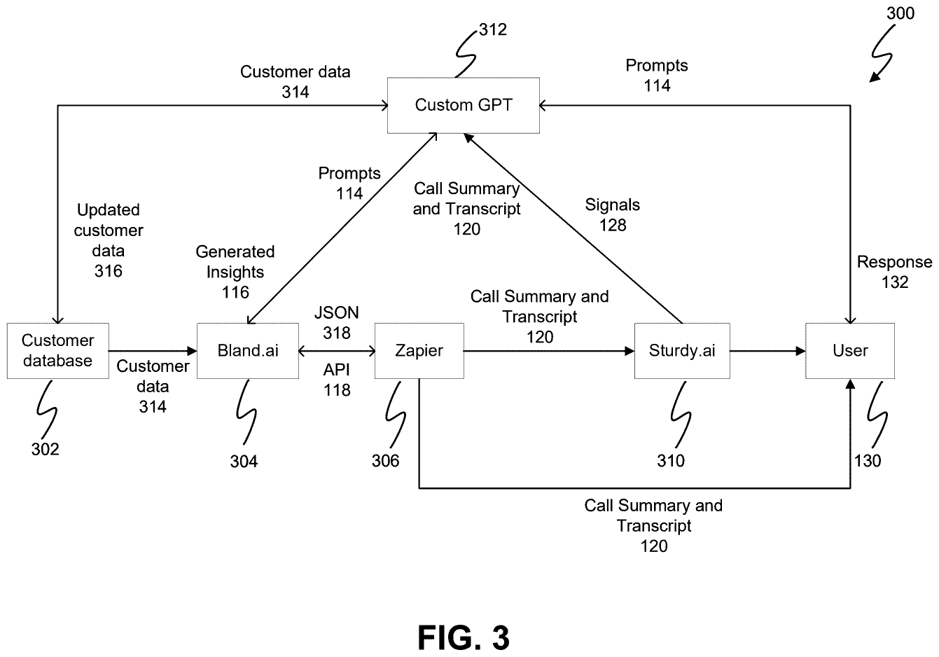

FIG. 3 depicts an exemplary AI-based automated voice dialer process 300 which is an embodiment of the AI-based automated voice dialer process 200 of FIG. 2. The input data 104 from a customer database 302 is fed to Bland.ai 304 as customer data 314. The customer data 314 is also shared as an input to a custom GPT 312 (an exemplary AI engine 112). Bland.ai 304 is a software tool that uses artificial intelligence capabilities to automate voice calls for organizations. Bland.ai 304 can generate a voice call imitating a human voice. Bland.ai 304 uses personalized scripts when communicating with customers. These personalized scripts are generated through the analysis of real-time customer call data. This real-time call data includes the customer database 302 and the generated insights 116. Bland.ai 304 receives the generated insights 116 from the custom GPT 312. The generated insights 116 include updated customer preferences based on the recent voice calls made to the existing customers. Bland.ai 304 interacts with the custom GPT 312 through prompts 114 that include guiding instructions for the custom GPT 312 for providing the insights 116. The input prompts 114 are dynamic and have additional utility. This utility is particularly useful when user 130 such as an account executive of the company directly interact with the custom GPT 312 for specific queries.

Bland.ai 304 processes the customer data 314 and initiates a voice call with the customer 134. After the completion of the call, Bland.ai 304 records the conversation and generates the call summary and transcript 120. Post generation of the call summary and transcript 120, Bland.ai 304 sends the webhook or Application Programming Interface (API) 118 request with the workflow automation tool 122 known as Zapier 306. Zapier 306 automates the workflow between the different software tools within the AI-based automated voice dialer system 100. The automation is achieved through the action of Zapier 306 based on customer interactions. Once Zapier 306 accepts the API 118 request, Bland.ai 304 sends the call summary and transcript 120 in JSON 318 format to Zapier 306.

Zapier 306 triggers two automations on receiving the JSON 318 file. Zapier 306 first sends the call summary and transcript 120 as an email to the user 130 and then again through Google chat for quick notification. In the second automation, the call summary and transcript 120 is sent to another software tool known as Sturdy.ai 310. Sturdy.ai 310 is primarily used in the AI-based automated voice dialer system 100 for generating signal 128 and improving the personalization process. Sturdy.ai 310 helps in improving the personalization part by predicting customer preferences in advance through call data. Sturdy.ai 310 analyzes the call summary and transcript 120 to generate signal 128 for the user 130. The call summary and transcript 120 are shared with the custom GPT 312 along with the signals 128 by Sturdy.ai 310 for predictive analysis of the real-time customer data. The results of the predictive analysis form the basis of generating insights for personalization. The signals 128 provides actionable items to the user 130 to take up necessary actions for addressing the issues highlighted by the customer 134. The custom GPT 312 further updates the customer database 302 with the updated customer data 316.

The user 130 connects with the custom GPT 312 by transferring dynamic prompts 114 as input. Prompts 114 also contains instructions for the custom GPT 312 to understand and analyze the call metadata and deep dive into specific conversations and high-level analytics. The custom GPT 312 has access to all the call data and built-in functions to generate calls to a specific conversation if required. Additionally, custom GPT 312 is pre-trained to identify patterns in customer behavior and analyze historical engagement metrics within the customer data 314. The instructions in prompt 114 allow the users to inquire about the details of individual calls, or request summaries, or request for general analytics across different calls. Prompts 114 further mention that the custom GPT 312 will generate the personalized response 132 for the user 130 with actionable insights and concise summaries. The actionable insights will further allow the user 130 to improve their process and address customer issues. Additionally, prompts 114 contains specific guidelines for the custom GPT 312 to use clear and practical language. Prompts 114 also emphasizes using a neutral and professional tone in the generated response 132 while avoiding overly technical jargon. Finally, prompts 114 also includes instructions to generate the response 132 seeking clarification if the query generated by user 130 is unclear.

Sturdy.ai 310 uses the data enrichment algorithm to analyze customer data 314 to identify patterns and generate insights 116. The exemplary pseudocode for data enrichment is shown below:
function enrich_data (data):
   insights=analyze_data(data)
   return enrich(data, insights)

In the above pseudocode the line function enrich_data (data): defines a function enrich_data( ) that takes in a single parameter named ‘data’. The parameter ‘data’ contains information regarding raw customer data 314. Within the function enrich_data( ), another function named analyze( )is called with the argument ‘data’. The result of the operation analyze_data(data) is assigned to another variable named ‘insights’. The value stored in the variable ‘insights’ which is the output of the operation, analyze_data(data)is returned as the output of the function enrich_data( ). The output generated is enriched customer data 314 which will be used as an input for Bland.ai 304 for generating personalized scripts.

Bland.ai 304 uses the script generation algorithm based on customer data 314 enriched by Sturdy.ai 310 and Custom GPT 312 as input. The exemplary pseudocode for the script generation algorithm is shown below:
function generate_script (data):
   script=create_personalized_script(data)
   return script

In the above pseudocode the line, function generate_script (data): defines a function, generate_script( ) that takes in a single parameter named ‘data’. The parameter ‘data’ contains information regarding customer data 314 that is enriched together with the generated insights 116. Within the function generate_script( ), another function named create_personalized_script( ) is called with the argument ‘data’. The result of create_personalized_script(data) is assigned to another variable name ‘script’. The value stored in the variable ‘script’ which is the output of the operation, create_personalized_script(data)is returned as the output of the function, generate_script( ). The received output is personalized scripts which will be used by Bland.ai 304 for voice calling.

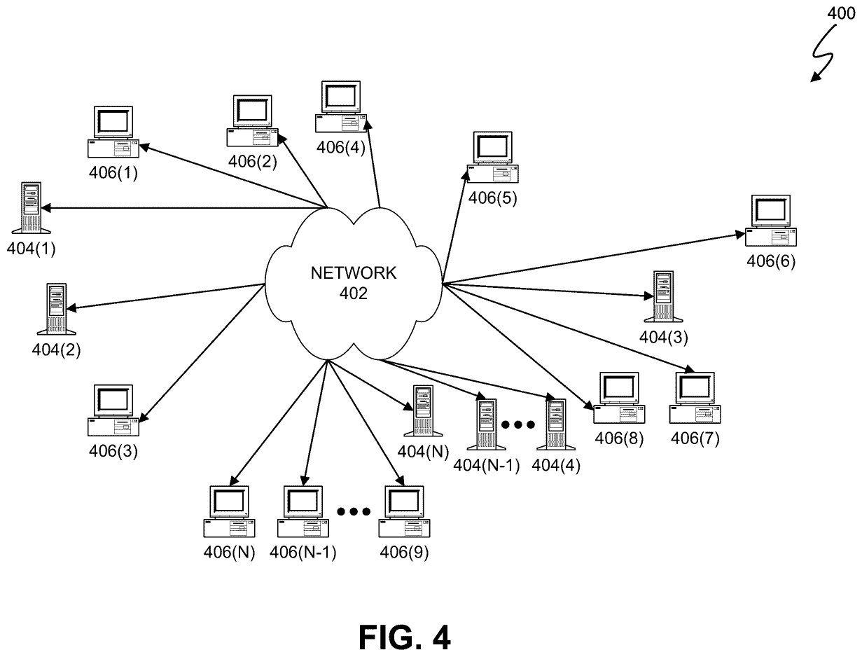

FIG. 4 is a block diagram illustrating a network environment 400 in which AI-based automated voice dialer system 100 and process 200 of generating personalized scripts for effective customer communication may be practiced. Network 402 (e.g. a private wide area network (WAN) or the Internet) includes several networked server computer systems 404(1)-(N) that are accessible by client computer systems 406(1)-(N), where N is the number of server computer systems connected to the network. Communication between client computer systems 406(1)-(N) and server computer systems 404(1)-(N) typically occurs over a network, such as a public switched telephone network over asynchronous digital subscriber line (ADSL) telephone lines or high-bandwidth trunks, for example, communications channels providing T1 or OC3 service. Client computer systems 406(1)-(N) typically access server computer systems 404(1)-(N) through a service provider, such as an internet service provider (“ISP”) by executing application-specific software, commonly referred to as a browser, on one of client computer systems 406(1)-(N).

Client computer systems 406(1)-(N) and server computer systems 404(1)-(N) are specialized computers programmed to improve conventional computer systems to implement and utilize AI-based automated voice dialer system 100 and process 200 of generating personalized scripts for effective customer communication. The type of computer system that can be specially programmed to implement and utilize AI-based automated voice dialer system 100 and process 200 of generating personalized scripts for effective customer communication includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the AI-based automated voice dialer system 100 and process 200 of generating personalized scripts for effective customer communication can be implemented using code stored in a tangible, non-transient computer-readable medium and executed by one or more processors. In at least one embodiment, the AI-based automated voice dialer system 100 and process 200 of generating personalized scripts for effective customer communication can be implemented completely in hardware using, for example, logic circuits and other circuits including field programmable gate arrays.

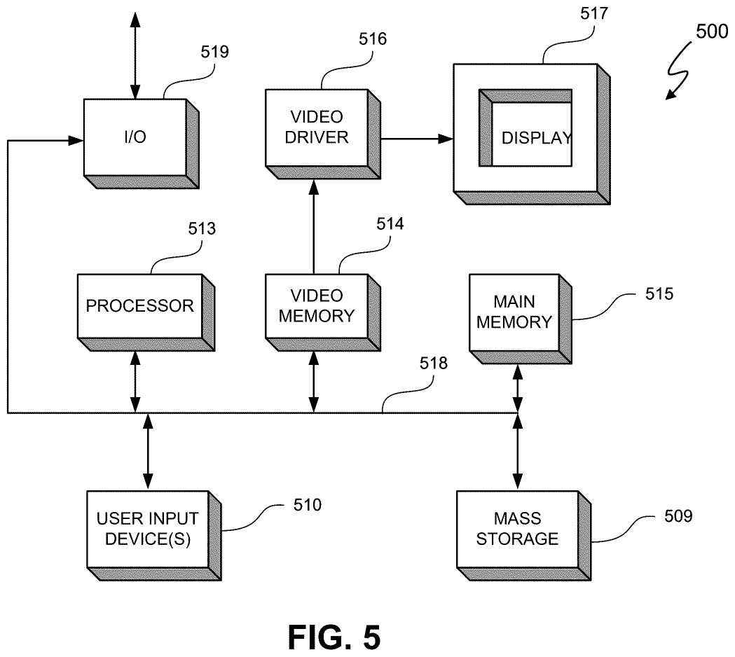

Embodiments of the AI-based automated voice dialer system 100 and process 200 of generating personalized scripts for effective customer communication can be implemented on a computer system such as a special-purpose, special-programmed computer 500 illustrated in FIG. 5. Input user device(s) 510, such as a keyboard and/or mouse, are coupled to a bi-directional system bus 518. The input user device(s) 510 are for introducing user input to the computer system and communicating that user input to processor 513. The computer system of FIG. 5 generally also includes a non-transitory video memory 514, non-transitory main memory 515, and non-transitory mass storage 509, all coupled to bi-directional system bus 518 along with input user device(s) 510 and processor 513. The mass storage 509 may include fixed and removable media, such as a hard drive, one or more CDs or DVDs, solid state memory including flash memory, and other available mass storage technology. Bus 518 may contain, for example, 32 of 64 address lines for addressing video memory 514 or main memory 515. The system bus 518 also includes, for example, an n-bit data bus for transferring DATA between and among the components, such as CPU 509, main memory 515, video memory 514, and mass storage 509, where “n” is, for example, 32 or 64. Alternatively, multiplex data/address lines may be used instead of separate data and address lines.

I/O device(s) 519 may provide connections to peripheral devices, such as a printer, and may also provide a direct connection to a remote server computer system via a telephone link or to the Internet via an ISP. I/O device(s) 519 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 509, into main memory 515 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 513, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 515 consists of dynamic random access memory (DRAM). Video memory 514 is a dual-ported video random access memory. One port of the video memory 514 is coupled to the video driver 516. The video driver 516 is used to drive the display 517. Video driver 516 is well-known in the art and may be implemented by any suitable means. This circuitry converts pixel DATA stored in video memory 514 to a raster signal suitable for use by display 517. Display 517 is a type of monitor suitable for displaying graphic images.

The computer system described above is for purposes of example only. The AI-based automated voice dialer system 100 and process 200 of generating personalized scripts for effective customer communication may be implemented in any type of computer system programming or processing environment. It is contemplated that the AI-based automated voice dialer system 100 and process 200 of generating personalized scripts for effective customer communication might be run on a stand-alone computer system, such as the one described above. The AI-based automated voice dialer system 100 and process 200 of generating personalized scripts for effective customer communication might also be run from a server computer systems system that can be accessed by a plurality of client computer systems interconnected over an intranet network. Finally, the AI-based automated voice dialer system 100 and process 200 of generating personalized scripts for effective customer communication may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method of enhancing customer engagement by automating voice calls and dynamic content delivery, the method comprises:
executing code using one or more processors of a computer system to cause the computer system to perform operations comprising:
receiving one or more input data from a customer data management database, wherein the one or more input data includes customer interaction data, historical engagement metrics, and customer feedback;
transferring a set of prompts to guide an AI engine, wherein the AI engine is pre-trained to identify patterns in customer behavior, analyze historical engagement metrics;
initiating an automatic communication with a customer using a calling tool;
generating a personalized script using a script generation tool, wherein the personalized scripts include customer details, caller details, call summary, call transcript, product details, and so on;
integrating a conversation tool with a workflow automation tool to transfer the call details and call summary to the user;
creating a signal based on the received call details, and call summary to a signal generator, wherein the signal is created by analyzing the received call details, and call summary and actions are taken to generate a response for the user, if needed.

2. The method of claim 1 wherein the customer data management database from which one or more input data is received includes a customer details, including name, company name, phone number, email address, details of product used, and so on, real-time customer interaction with the AI engine, customer feedback, and so on.

3. The method of claim 1 wherein the one or more input data received from the customer data management database is in CSV format.

4. The method of claim 1, wherein the prompts include rules, guidelines, and output structure to guide the AI engine to analyze the call summary and call transcript of the customer and generate personalized response for the user.

5. The method of claim 1 wherein the personalized scripts generated by the script generation tool is multilingual, thereby enabling personalized engagement across different languages and regions.

6. The method of claim 1 wherein the automated communication established with the customer is in the form of a voice call.

7. The method of claim 1 wherein the automated communication with the customer is continuously monitored on a real-time basis to dynamically adapt to the content of ongoing communications, thereby ensuring personalized and relevant customer engagement.

8. The method of claim 1 wherein the workflow automation tool sends the request to the conversation tool using an API, thereby notifying users by sending the call details, and the call summary with the user.

9. The method of claim 1 wherein the workflow automation tool may also integrate with a third-party application tool used for making automatic calls.

10. The method of claim 1 wherein the user takes the necessary action based on the received call transcript, and call summary, including, scheduling future meetings automatically, responding to the user, if needed.

11. The method of claim 10 wherein the AI engine responds to the user on a real-time basis based on the customer details and call details stored within the AI engine.

12. The method of claim 1 wherein the conversation tool transfers the call summary, and the call transcript to the workflow automation tool in JSON format.

13. The method of claim 1 wherein the customer details stored in the customer management database keep on updating on a real-time basis based on the interaction of the user with the AI engine, and the call details.

14. The method of claim 1 further comprises:
applying predictive analysis to the customer data to predict future customer needs and engagement opportunities based on historical trends and real-time data patterns;
suggesting proactive customer engagement actions based on the results of the predictive analysis, including recommending additional services, scheduling follow-up communications, or addressing potential customer concerns.

15. A system of enhancing customer engagement by automating voice calls and dynamic content delivery comprises:
one or more processors of a computer system;
memory, coupled to the one or more processors, that store code and execution of the code by the one or more processors causes the computer system to perform operations comprising:
receiving one or more input data from a customer data management database, wherein the one or more input data includes customer interaction data, historical engagement metrics, and customer feedback;
transferring a set of prompts to guide an AI engine, wherein the AI engine is pre-trained to identify patterns in customer behavior, analyze historical engagement metrics;
initiating an automatic communication with a customer using a calling tool; generating a personalized scripts using a script generation tool, wherein the personalized scripts include customer details, caller details, call summary, call transcript, product details, and so on;
integrating a conversation tool with a workflow automation tool to transfer the call details, and call summary to the user;
creating a signal based on the received call details, and call summary to a signal generator, wherein the signal is created by analyzing the received call details, and call summary and actions are taken to generate a response for the user, if needed.

16. The system of claim 15 wherein the one or more input data received from the customer data management database is in CSV format.

17. The system of claim 15 wherein the workflow automation tool sends the request to the conversation tool using an API, thereby notifying users by sending the call details, and the call summary with the user.

18. The system of claim 15 wherein the automated communication established with the customer is conducted as a voice call, managed by the calling tool, ensuring real-time, dynamic delivery of personalized scripts.

19. The system of claim 15 wherein the workflow automation tool integrates t with third-party communication services, expanding the range of communication channels to include SMS, email, and social media platforms, thereby increasing customer engagement.
